(19) United States
(12) Patent Application Publication
(10) Pub. No.: US 2025/0226676 A1
(43) Pub. Date: Jul. 10, 2025

(54) CHARGER AND CHARGING METHOD FOR BATTERY PACK

(71) Applicant: ZHEJIANG TEKANG ELECTRONIC TECHNOLOGY CO., LTD., Jiaxing, Zhejiang (CN)

(72) Inventors: Binshun QIU, Jiaxing, Zhejiang (CN); Chao JING, Jiaxing, Zhejiang (CN); Yonghao ZHOU, Jiaxing, Zhejiang (CN)

(73) Assignee: ZHEJIANG TEKANG ELECTRONIC TECHNOLOGY CO., LTD., Jiaxing, Zhejiang (CN)

(21) Appl. No.: 18/852,530

(22) PCT Filed: May 30, 2023
(86) PCT No.: PCT/CN2023/097001

§ 371 Date: Sep. 30, 2024

(30) Foreign Application Priority Data
May 31, 2022 (CN) 202210606603.0

(51) Int. Cl. H02J 7/00

(52) U.S. Cl. CPC H02J 7/0036; H02J 7/0045; H02J 7/0047; H02J 7/00045

(57) ABSTRACT

A charger and charging method for a battery pack are provided. The charger comprises a switch provided on a charging loop of a power supply, and a control circuit for controlling on/off of the switch; wherein a first terminal of the control circuit is connected to the switch, and a second terminal of the control circuit is configured to be connected to a discharge terminal of the battery pack; the battery pack supplies power to the control circuit when the discharge terminal of the battery pack is connected to the second terminal of the control circuit; and the control circuit, when being energized, controls to close the switch to complete the charging loop.

This application claims priority to Chinese Patent Application No. 202210606603.0 titled “CHARGER AND CHARGING METHOD FOR BATTERY PACK”, filed on May 31, 2022 with the China National Intellectual Property Administration (CNIPA), which is incorporated herein by reference in its entirety.

### FIELD

The present disclosure relates to the field of charging technology, and in particular to a charger and a charging method for a battery pack.

### BACKGROUND

In daily life, battery packs are used in a wide range of applications, a commonly used one is a lithium battery pack. Generally, a dedicated charger is provided for charging the battery pack. The charger for the battery pack has two ports. One of the ports serves as a power port for connecting to a power supply, and the other port serves as a plug port for charging the battery pack. Conventionally, the plug terminal for charging the battery pack is in a plug-in type, and the battery pack has a socket matching the plug terminal for charging. After the plug of the charger is plugged into the socket of the battery pack, the battery pack can be charged. To satisfy various high-power electrical appliances, the battery packs are providing rising voltages. When supplying power to the battery pack, there is a risk of electric shock caused by accidental contact with the plug. A common solution at present is to dispose a protective cover on the plug, to prevent accidental contact with the plug. However, the protective cover can realize protection only when the cover is closed. When charging the battery pack, the protective cover needs to be opened, and the risk of electric shock still exists. In addition, a patent application CN201620556803.X discloses a dual protection circuit of a charger for a high voltage battery pack that satisfies safety regulations. When the battery pack needs to be charged and is plugged into the charger, the remaining power in the battery pack supplies power to a second switch control module 3. In this case, a MOSFET M in the second switch control module 3 is turned on and a coil in a second relay K2 is energized, to facilitate the engagement of the second relay K2. After the second relay K2 is activated, the external power supply causes the MOSFET M to be in an on state. At this time, the charger has started to supply power. Even if the battery pack is unplugged, the MOSFET M is still in the on state since the MOSFET M is still connected to the external power supply. Hence, the second switch K2 is still on, and terminals of the charger may still be energized, resulting in a safety hazard. In solutions where the detection of insertion of the battery pack and the subsequent activation of the relay is realized based on an on-off signal of mechanical switches or non-contact switches or photoelectric detection control switches, the number of switches is increased, resulting in an increased cost, an increased probability of failure of the circuit system, and a reduced reliability of the system. This is because that the mechanical switch or non-contact switch or photoelectric detection control switch may fail and in turn the switch signal would not change, that is, the detection switch cannot be closed normally after a normal insertion of the battery pack into the charging terminal of the charger, so that the conduction signal cannot be generated. In this case, a signal indicating that the battery pack is plugged into the charger cannot be generated, and thereby the relay control terminal in the charger cannot receive a correct signal and cannot be activated, so that the charging system cannot be charged normally. The safety hazards remain in a case where the mechanical switch or non-contact switch or photoelectric detection control switch fails and the relay is activated unexpectedly.

In view of the above, a problem to be solved by those skilled in the art is to propose a charger with which the risk of electric shock is reduced.

### SUMMARY

An objective of the present disclosure is to provide a charger and a charging method for a battery pack, with which a risk of electric shock is reduced.

To solve the technical problem, a charger for a battery pack is provided in the present disclosure. The charger includes a switch provided on a charging loop of a power supply, and a control circuit 13 for controlling on/off of the switch;
a first terminal of the control circuit 13 is connected to the switch, and a second terminal of the control circuit 13 is configured to be connected to a discharge terminal of the battery pack 10; the battery pack 10 supplies power to the control circuit 13 when the discharge terminal of the battery pack 10 is connected to the second terminal of the control circuit 13; and the control circuit 13, when being energized, controls to close the switch to complete the charging loop.

Preferably, the control circuit 13 is powered by only the battery pack 10; and in a case where the battery pack 10 does not supply power to the control circuit 13, the control circuit 13 controls to open the switch to disconnect the charging loop.

Preferably, the switch is a relay K, and the relay K has a normally open contact;
the first terminal of the control circuit 13 is connected to a coil of the relay K; and the control circuit 13, when being energized, controls to energize the coil of the relay K.

Preferably, the charger further includes a battery pack status detection circuit 11. The battery pack status detection circuit 11 is configured to detect a present status of the battery pack 10. The present status includes a voltage and temperature of the battery pack 10, and a battery model and a battery capacity of the battery pack 10;
the control circuit 13 includes a first resistor R1, a second resistor R2, a transistor Q4, and a diode D;
the coil of the relay K, a collector and an emitter of the transistor Q4, and the first resistor R1 are connected in series between the discharge terminal of the battery pack 10 and the ground;
the battery pack status detection circuit 11 is connected to a base of the transistor Q4, and is configured to input a voltage to the transistor Q4 in a case where the present status meets a charging requirement of the battery pack 10;
a first terminal of the second resistor R2 is connected to the base of the transistor Q4, and a second terminal of the second resistor R2 is connected to the emitter of the transistor Q4; an anode of the diode D is connected to a terminal of the coil of the relay K close to the ground, and a cathode of the diode D is connected to a terminal of the coil of the relay K close to the discharge terminal of the battery pack 10.

Preferably, the charger further includes a constant voltage control circuit 12; the constant voltage control circuit 12 includes a switching tube, a three-terminal regulator U, a capacitor C, a third resistor R3, and a fourth resistor R4; the switching tube includes a first switching tube;
a first terminal of the first switching tube, a first terminal of the third resistor R3, and a ground terminal of the three-terminal regulator U are all grounded;
a second terminal of the first switching tube, a second terminal of the third resistor R3, a sampling terminal of the three-terminal regulator U, a first terminal of the fourth resistor R4, and a first terminal of the capacitor C are connected to each other;
a control terminal of the three-terminal regulator U, a second terminal of the capacitor C, and a second terminal of the fourth resistor R4 are all connected to the power supply;
a control terminal of the first switching tube is connected to the battery pack status detection circuit 11; and the battery pack status detection circuit 11 is configured to control to enable conduction between the first terminal and the second terminal of the first switching tube, in a case where the present status meets the charging requirement.

Preferably, the switching tube further includes a second switching tube;
the switching tubes are connected in series between the control terminal of the three-terminal regulator U and the ground;
a control terminal of the second switching tube is connected to the emitter of the transistor Q4 in the control circuit 13; and the second switching tube conducts when the emitter of the transistor Q4 is energized.

Preferably, the first switching tube and/or the second switching tube are in a quantity of more than one, and are all connected in series.

Preferably, the switching tube is a MOSFET, the first switching tube is a first MOSFET, and the second switching tube is a second MOSFET;
a gate of the first MOSFET is connected to the battery pack status detection circuit 11; the battery pack status detection circuit 11 is configured to input a voltage to the gate of the first MOSFET in a case where the present status meets the charging requirement;
a gate of the second MOSFET is connected to the emitter of the transistor Q4;
a drain and a source in the MOSFET serve as a first terminal and a second terminal of the MOSFET, respectively.

Preferably, the switch is a MOSFET;
a drain of a MOSFET Q7 serving as the switch is connected to the power supply, and a source of the MOSFET Q7 serving as the switch is connected to a positive electrode of the battery pack 10;
the first terminal of the control circuit 13 is connected to a gate of the MOSFET Q7 serving as the switch; and the control circuit 13, when being energized, controls to enable conduction between the source and the drain of the MOSFET Q7 serving as the switch.

Preferably, the MOSFET Q7 serving as the switch is in a quantity of more than one;
the MOSFET Q7 serving as the switch are connected in series through mutual connections of drains and sources; and
the first terminal of the control circuit 13 is connected to gates of the MOSFETs Q7 serving as the switch.

Preferably, the charger further includes a blocking element;
the blocking element is disposed between the power supply and the battery pack 10, for preventing the battery pack 10 from charging the power supply.

Preferably, the blocking element is a diode;
an anode of the diode is close to the power supply, and a cathode of the diode is close to the battery pack 10.

Preferably, the blocking element is a MOSFET;
a source of a MOSFET Q8 serving as the blocking element is close to the power supply, and a drain of the MOSFET Q8 serving as the blocking element is close to the battery pack 10; and
the first terminal of the control circuit 13 is connected to a gate of the MOSFET Q8 serving as the blocking element.

Preferably, the charger further includes a battery pack status detection circuit 11 configured to detect a present status of the battery pack 10;
the control circuit 13 includes a control MOSFET Q5, a control transistor Q6, a fifth resistor R5, a sixth resistor R6, and a seventh resistor R7;
the battery pack status detection circuit 11 is connected to a gate of the control MOSFET Q5, and is configured to input a voltage to the control MOSFET Q5 in a case where the present status meets a charging requirement of the battery pack 10;
a drain of the control MOSFET Q5 serves as the second terminal of the control circuit 13 and is configured to be connected to the discharge terminal of the battery pack 10;
a source of the control MOSFET Q5, a first terminal of the fifth resistor R5, and a first terminal of the sixth resistor R6 are connected to each other; a second terminal of the fifth resistor R5 is grounded;
a second terminal of the sixth resistor R6 is connected to a base of the control transistor Q6, an emitter of the control transistor Q6 is grounded, and a collector of the control transistor Q6 is connected to a first terminal of the seventh resistor R7; and
a second terminal of the seventh resistor R7 serves as the first terminal of the control circuit 13, and is configured to be connected to the gate of the MOSFET Q7 serving as the switch.

Preferably, the charger further includes a constant voltage control circuit 12; the constant voltage control circuit 12 includes a switching tube, a three-terminal regulator U, a capacitor C, a third resistor R3, and a fourth resistor R4; the switching tube includes a first switching tube;
a first terminal of the first switching tube, a first terminal of the third resistor R3, and a ground terminal of the three-terminal regulator U are all grounded;
a second terminal of the first switching tube, a second terminal of the third resistor R3, a sampling terminal of the three-terminal regulator U, a first terminal of the fourth resistor R4, and a first terminal of the capacitor C are connected to each other;
a control terminal of the three-terminal regulator U, a second terminal of the capacitor C, and a second terminal of the fourth resistor R4 are all connected to the power supply;
a control terminal of the first switching tube is connected to the battery pack status detection circuit 11; and the battery pack status detection circuit 11 is configured to control to enable conduction between the first terminal and the second terminal of the first switching tube in a case where the present status meets the charging requirement.

Preferably, the switching tube further includes a second switching tube;
the switching tubes are connected in series between the control terminal of the three-terminal regulator U and the ground;
a control terminal of the second switching tube is connected to the source of the control MOSFET Q5 in the control circuit 13; and the second switching tube conducts when the source of the control MOSFET Q5 is energized.

Preferably, the sixth resistor R6 and the control transistor Q6 are both in a quantity of more than one; and
the control transistors Q6 are connected in series through mutual connections of collectors and emitters.

To solve the above technical problem, a charging method for a battery pack is further provided in the present disclosure. The method is applied to a charger for a battery pack including a switch and a control circuit 13, where the switch is provided on a charging loop of a power supply, a first terminal of the control circuit 13 is connected to the switch, a second terminal of the control circuit 13 is configured to be connected to a discharge terminal of the battery pack 10; and the method includes:
controlling, when being energized, to close the switch to complete the charging loop; where the battery pack 10 supplies power to the control circuit 13 when the discharge terminal of the battery pack 10 is connected to the second terminal of the control circuit 13.

Preferably, the charger for the battery pack further includes a battery pack status detection circuit 11, the battery pack status detection circuit 11 is configured to detect a present status of the battery pack 10, and the battery pack status detection circuit 11 is connected to the control circuit 13; and
before the controlling, when being energized, to close the switch to complete the charging loop, the method further includes:
receiving the present status detected by the battery pack status detection circuit 11; and
the controlling, when being energized, to close the switch to complete the charging loop includes:
controlling to close the switch to complete the charging loop, in a case where the discharge terminal of the battery pack 10 is connected to the second terminal of the control circuit 13 and the present status meets a charging requirement; where the present status includes a voltage and temperature of the battery pack 10, and a battery model and a battery capacity of the battery pack 10.

Preferably, the charger of the battery pack further includes a constant voltage control circuit 12 provided in the charging loop; the constant voltage control circuit 12 is configured to limit a voltage of the charging loop when the constant voltage control circuit is not energized, and increase the voltage of the charging loop when the constant voltage control circuit is energized; and the method further includes:
controlling, when being energized, to energize the constant voltage control circuit 12.

According to the present disclosure, the charger for a battery pack includes the switch provided on the charging loop of the power supply, and the control circuit for controlling on/off of the switch. The first terminal of the control circuit is connected to the switch, and the second terminal of the control circuit is configured to be connected to the discharge terminal of the battery pack; the battery pack supplies power to the control circuit when the discharge terminal of the battery pack is connected to the second terminal of the control circuit; and the control circuit, when being energized, controls to close the switch to complete the charging loop. According to the solution provided in the present disclosure, the control circuit draws power from the discharge terminal of the battery pack. When the battery pack is not connected to the charger, the plug on the charger for powering the battery pack is not energized, and therefore the risk of electric shock when charging the battery pack is reduced. In addition, the charger provided in the present disclosure has a simple structure with fewer electronic components, which lead to a low cost and fewer potential fault sources in the circuit structure, achieving a higher reliability. Compared with the solution in the patent application No. CN201620556803.X, the present disclosure proposes that the on/off operation of the switch depends on a power supply from the battery pack. As the battery pack is unplugged, the switch loses power and is switched off, so that the output terminal of the charger in no way is energized. In this way, a situation where the output terminal is energized when the battery pack is unplugged is avoided, realizing higher safety. Compared with other related conventional technologies, the present disclosure has an improved safety, a simpler circuit structure, a reduced number of switches, a reduced cost, and a better reliability.

A charging method for a battery pack is further provided in the present disclosure. The charging method corresponds to the charger for a battery pack described above, and therefore has the same beneficial effects as the charger for a battery pack.

### BRIEF DESCRIPTION OF THE DRAWINGS

For clearer illustration of the technical solutions according to embodiments of the present disclosure, hereinafter briefly described are the drawings to be applied in embodiments of the present disclosure. Apparently, the drawings in the following descriptions are only some embodiments of the present disclosure, and other drawings may be obtained by those skilled in the art based on the provided drawings without any creative effort.

FIG. 1 is a structural diagram of a charger according to an embodiment of the present disclosure;

FIG. 2 is a structural diagram of a charger including a battery pack status detection circuit according to an embodiment of the present disclosure;

FIG. 3 is a structural diagram of a charger including a constant voltage control circuit according to an embodiment of the present disclosure;

FIG. 4 is a structural diagram of a charger in which a switch is a MOSFET according to an embodiment of the present disclosure.

Reference signs in the drawings are illustrated below:
10 Battery pack;
11 Battery pack status detection circuit;
12 Constant voltage control circuit;
13 Control circuit.

### DETAILED DESCRIPTION

Hereinafter technical solutions of embodiments of the present disclosure are described clearly and completely in conjunction with the drawings of the embodiments of the present disclosure. Apparently, the embodiments described below are only some embodiments, rather than all the embodiments of the present disclosure. Any other embodiments obtained by those skilled in the art based on the embodiments in the present disclosure without any creative effort shall fall within the protection scope of the present disclosure.

A core of the present disclosure is to provide a charger and a charging method for a battery pack, with which a risk of electric shock is reduced.

To enable those skilled in the art to better understand the solution in the present disclosure, the present disclosure is described in further detail below in conjunction with the accompanying drawings and specific embodiments.

In daily life, a variety of electrical appliances need to use battery packs, and the battery packs for different electrical appliances have different models. Therefore, there is generally a dedicated charger for charging a battery pack. The charger for a battery pack has two ports. One of the ports serves as a power port connected to a power supply. The power supply may be a socket that outputs 220V mains power, or may be a socket that outputs 110V mains power, according to standards of countries and regions. The 220V mains socket here is only an example for illustration. When charging the battery pack, the power port on the charger is plugged into the socket. The other port on the charger is a plug port for charging the battery pack. The type of the port is not limited. The plug port for charging the battery pack is usually a plug-in type, and the battery pack has a power receiving socket for charging. Charging for the battery pack can be realized when the charger is plugged into a power source and the plug of the charger is plugged into the power receiving socket of the battery pack. However, when powering the battery pack, the plug may be accidentally touched, which may easily cause a risk of electric shock. Other types of ports also have the risk of electric shock. The plug port in the plug-in type is mentioned here merely as an example.

To solve the above problem, a charger for a battery pack is provided in the present disclosure. The charger includes a switch provided on a charging loop of a power supply, and a control circuit 13 for controlling on/off of the switch. A first terminal of the control circuit 13 is connected to the switch, and a second terminal of the control circuit 13 is configured to be connected to a discharge terminal of the battery pack 10. In an embodiment, the discharge terminal is arranged in a power receiving port. The battery pack 10 supplies power to the control circuit 13 when the discharge terminal of the battery pack 10 is connected to the second terminal of the control circuit 13. The control circuit 13, when being energized, controls to close the switch to complete the charging loop.

It should be noted that in the charger for a battery pack provided in the embodiment of the present disclosure, models of circuit elements and structures of circuits are not limited, as long as effects can be achieved correspondingly. For example, the number and type of the switch are not limited. The switch may be a relay K, or a switching tube such as a bipolar junction transistor, a metal-oxide semiconductor field-effect transistor (MOSFET) and the like. Correspondingly, varying types of the switch lead to different types of the control circuit 13 and different connections between the control circuit 13 and the switch. In a case where a switching tube is adopted as the switch, multiple switching tubes are generally provided in the charging loop to prevent the charging loop from unexpected conducting due to failure of some of the switching tubes. In a case where a normally open relay K is adopted as the switch, the control circuit 13 is a loop where the coil of the relay K is located. When the coil is not energized, a moving contact of the relay K is connected to one of the fixed contacts. In this case, the relay K is disconnected, and the charging loop of the power supply is disconnected. When the coil is energized, the moving contact of relay K jumps to the other fixed contact. In this case, the relay K is activated. In a case where the charging loop includes only one switch namely the relay K, the charging loop is completed at this time, and the power supply supplies power to the battery pack 10. In a case where a MOSFET is adopted as the switch, a drain and a source of the MOSFET are connected to the charging loop. When a gate of the MOSFET receives a voltage or current, the drain and the source are connected, and a current flows in the charging loop.

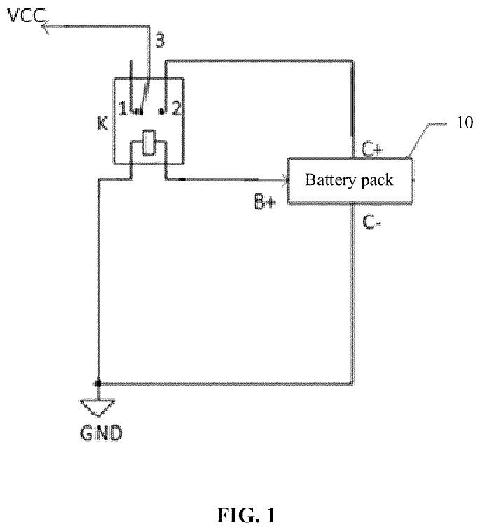

In the solution where only one relay K is used as the switch, control coils of different control circuits 13 are energized in different ways. A solution with a simpler circuit structure is provided here. FIG. 1 shows a structural diagram of a charger according to an embodiment of the present disclosure. As shown in FIG. 1, a moving contact of the relay K is connected to a power supply, a first terminal of the coil of the relay K is grounded, a second terminal of the coil of the relay K is connected to a discharge terminal B+ of the battery pack 10, a charging terminal C− in the battery pack 10 is grounded, and the other charging terminal C+ is connected to a fixed contact 2 the relay K. As the battery pack 10 is plugged into the charger through the charging terminals C+ and C−, the discharge terminal B+ of the battery pack 10 starts to supply power to the coil. In this case, the moving contact of the relay K jumps from the fixed contact 1 to the other fixed contact 2, so that the relay K is activated. Normally, there is a small amount of residual electricity in the battery pack, and the coil of the relay K requires a small amount of electricity. Therefore, the electricity discharged from the discharge terminal of the battery pack is enough to drive the jumping of the moving contact of the relay K. Considering some special circumstances, a small battery pack, separately allocated from the battery pack, is specially configured for powering the coil of the relay K. A key point is that the control circuit 13 is powered by the battery pack. The control circuit 13 has no power supply when the battery pack is not plugged, and therefore cannot control to close the switch. In this way, even if the power port is plugged into the socket, the charging port has no voltage, thereby ensuring safety. When the plug port is connected to the power receiving socket of the battery pack, and the discharge terminal of the battery pack discharges, the relay is activated and allows power supply. In this way, safe charging for the battery pack is ensured. The solutions provided by the present disclosure are not limited to the above-described embodiments. The above solution has a simpler circuit structure, a lower cost, and fewer sources of electronic component failure. In an actual application, any one of the above solutions may be adopted, or other solutions may be used, or a combination based on the above examples may be made. For example, the switch includes a MOSFET and a relay K, which are connected in series in the charging loop. The charging loop is switched on only when the MOSFET and the relay K are both switched on.

In applications, various situations may occur. For example, a model of the charger does not match the battery pack 10, or an internal structure of the battery pack 10 is damaged. In such cases, a serious accident may occur when charging the battery pack 10 through the charger. Hence, the charger for the battery pack 10 may further include a battery pack status detection circuit 11. The battery pack status detection circuit 11 is configured to detect a present status of the battery pack 10. In a case where the present status of the battery pack 10 meets a charging requirement, the battery pack status detection circuit 11 drives the control circuit 13 to close the switch, thereby the charging loop is energized. A structure of the battery pack status detection circuit 11 is not specifically limited here. Under normal circumstances, communication is established between the battery pack 10 and the charger as the battery pack 10 is connected to the charger. The battery pack status detection circuit 11 may detect a communication status of the battery pack and the charger to determine whether the present status of the battery pack 10 meets the charging requirement. In addition, the charger may further include a constant voltage control circuit 12 for ensuring voltage stability in the charging loop.

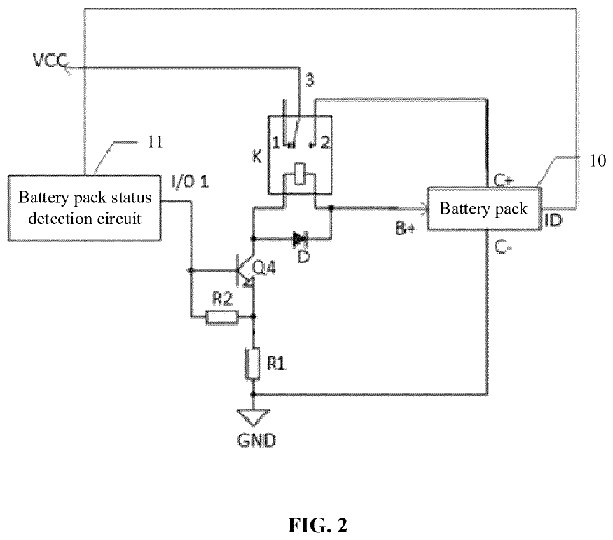

The following illustrates an actual circuit diagram. In the example, a relay K is adopted as the switch. FIG. 2 is a structural diagram of a charger including a battery pack status detection circuit according to an embodiment of the present disclosure. As shown in FIG. 2, main components include a transistor Q4, a first resistor R1, a second resistor R2, a relay K, a diode D, a battery pack 10, and a battery pack status detection circuit 11. In this example, a power receiving socket of the battery pack 10 has four terminals, i.e., charging terminals C+ and C−, a discharge terminal B+, and a communication terminal ID. The battery pack status detection circuit 11 may be a single-chip microcomputer and be connected to the circuit through an I/O port 1. A moving contact 3 of the relay K is connected to the power supply. When the coil of the relay K is not energized, the moving contact 3 of the relay K is connected to a fixed contact 1 of the relay K, and the charging loop is not completed. A second terminal of the coil of the relay K is configured to be connected to the discharge terminal B+ of the battery pack 10, and a first terminal of the coil of the relay K is connected to a collector of the transistor Q4. The battery pack status detection circuit 11 is connected to the communication terminal ID of the battery pack 10, and is configured to detect a present status of the battery pack 10. The I/O port 1 of the battery pack status detection circuit 11 is connected to a base of the transistor Q4, and is configured to input a voltage to the transistor Q4 in a case where the present status meets a charging requirement of the battery pack 10. An emitter of the transistor Q4 is connected to a first terminal of the first resistor R1, and a second terminal of the first resistor R1 is grounded. A first terminal of the second resistor R2 is connected to the base of the transistor Q4, and a second terminal of the second resistor R2 is connected to the emitter of transistor Q4. A first terminal of the diode D is connected to the first terminal of the coil, and a second terminal of the diode D is connected to the second terminal of the coil. When the discharge terminal of the battery pack 10 is connected to the second terminal of the coil of the relay K, the control circuit 13 is energized, but the coil is not energized at this time. When the battery pack status detection circuit 11 detects that the present status of the battery pack 10 meets the charging requirement, a voltage is inputted to the base of transistor Q4 through the I/O port 1, to control to turn on the transistor Q4. In this case, the coil of the relay K is energized, and the moving contact 3 of the relay K jumps and is connected to the fixed contact 2. Hence, the entire charging loop is energized.

According to the present disclosure, the charger for a battery pack includes the switch provided on the charging loop of the power supply, and the control circuit for controlling on/off of the switch. The first terminal of the control circuit is connected to the switch, and the second terminal of the control circuit is configured to be connected to the discharge terminal of the battery pack; the battery pack supplies power to the control circuit when the discharge terminal of the battery pack is connected to the second terminal of the control circuit; and the control circuit, when being energized, controls to close the switch to complete the charging loop. According to the solution provided in the present disclosure, the control circuit draws power from the discharge terminal of the battery pack. When the battery pack is not connected to the charger, the plug on the charger for powering the battery pack is not energized, and therefore the risk of electric shock when charging the battery pack is reduced.

To ensure that the plug on the charger for powering the battery pack is not energized when the battery pack is not connected to the charger, in the solution provided by an embodiment of the present disclosure, the control circuit 13 is powered by only the battery pack 10; and in a case where the battery pack 10 does not supply power to the control circuit 13, the control circuit 13 controls to open the switch to disconnect the charging loop. As can be seen, in the present disclosure, an on/off state of the switch depends on power supplied from the battery pack. When the battery pack is unplugged, the switch loses power and is opened, so that there is no power on the output terminal of the charger. Hence, a problem that the output terminal is energized after the battery pack is unplugged is avoided. In comparison, in the solution disclosed in patent application No. CN201620556803.X, when the battery pack is unplugged, the charger terminal may still be energized due to being connected to the external power source. Hence, the present disclosure achieves a higher safety.

In the solution where only one normally open relay K is used as the switch, control coils of different control circuits 13 are energized in different ways. In a simple solution, the first terminal of the control circuit 13 is connected to a coil of the relay K; and the control circuit 13, when being energized, controls to energize the coil. For example, a first terminal of the coil of the relay K is grounded; and a second terminal of the coil of the relay K is configured to be connected to the discharge terminal of the battery pack 10 to draw power from the battery pack 10. As the battery pack 10 is plugged into the charger, the discharge terminal of the battery pack 10 starts to supply power to the coil. In this case, the moving contact of the relay K jumps from a fixed contact to another fixed contact, so that the relay K is activated. In this solution, the power supply for the coil is the battery pack 10. Therefore, the coil can be energized only when connected to the battery pack 10. The coil of the relay K is avoided from being mistakenly energized due to component damage.

In the above embodiment, the control circuit 13 mainly depends on the connection between the second terminal of the coil and the discharge terminal of the battery pack 10. The battery pack 10 starts to supply power after plugged. In applications, various situations may occur. For example, a model of the charger does not match that of the battery pack 10, or an internal structure of the battery pack 10 is damaged. In such cases, a serious accident may occur when charging the battery pack 10 through the charger. Therefore, in a solution provided in an embodiment of the present disclosure, the charger further includes a battery pack status detection circuit 11. In addition, the control circuit 13 further includes a first resistor R1, a second resistor R2, a transistor Q4, and a diode D. It should be noted that the transistor Q4 here is different from the transistor serving as the switch in the above description. The transistor Q4 here serves as a part of the control circuit 13. The battery pack status detection circuit 11 is configured to detect a present status of the battery pack 10. Content of the present status is not specifically limited. The present status in the embodiment of the present disclosure includes a voltage and temperature of the battery pack 10, and a battery model and a battery capacity of the battery pack 10. The coil, a collector and an emitter of the transistor Q4, and the first resistor RI are connected in series between the discharge terminal of the battery pack 10 and the ground. The battery pack status detection circuit 11 is connected to a base of the transistor Q4, and is configured to input a voltage to the transistor Q4 in a case where the present status meets a charging requirement of the battery pack 10. A first terminal of the second resistor R2 is connected to the base of the transistor Q4, and a second terminal of the second resistor R2 is connected to the emitter of the transistor Q4. An anode of the diode D is connected to a terminal of the coil of the relay K close to the ground, and a cathode of the diode D is connected to a terminal of the coil of the relay K close to the discharge terminal of the battery pack 10.

In an embodiment of the present disclosure, the transistor Q4 is added to the loop where the coil of the relay K is located, and the base of the transistor Q4 is connected to the battery pack status detection circuit. After the battery pack is plugged into the charger, the coil of the relay K has a power supply, but the loop of the coil is not completed. Only when the voltage and temperature of the battery pack, the battery model and the battery capacity of the battery pack, and the like, all meet the charging requirement, the battery pack status detection circuit inputs a voltage to the transistor Q4 to complete the loop of the coil, thereby controlling jumping of the contact of the relay K. In the solution provided by the embodiment of the present disclosure, the battery pack is not charged in situations where a model of the charger does not match a model of the battery pack, or an internal structure of the battery pack is damaged, or the like. Hence, serious charging accidents are avoided. For example, in FIG. 2, if the I/O port 1 of the battery pack status detection circuit outputs a fixed voltage of 5V, the transistor Q4 produces a voltage drop of 0.7V, thereby obtaining a voltage of 4.3V. The first resistor R1 may have a constant current resistance of 300Ω. A constant current in the loop of the coil is finally achieved. Since the voltage across the coil of relay K is constant under the constant current, the voltage across both ends of the working coil of the relay K is clamped within an appropriate working range and does not change with the voltage of the battery pack. This is because the loop of the coil in the relay is powered by the battery pack in the embodiment. The voltage of the battery pack varies according to a voltage platform used and an actual situation, and is not a fixed value. Nevertheless, the voltage across the coil of the relay must be a fixed value, to avoid the failure of switching on due to an under-voltage or burning out of the coil of the relay due to an over-voltage. In an embodiment, a constant current circuit may be formed by the transistor Q4 and the first resistor R1, and the voltage across both sides of the coil of the relay may be controlled by controlling the circuit current. In this way, failure of closing contacts of the relay due to an under-voltage or burning out of the coil of the relay due to an over-voltage is avoided. In addition, the relay in the embodiments of the present disclosure may be determined based on different charging voltage ranges. For example, a relay with 12V/24V coil voltage may be adopted.

Additionally, in actual applications, the contacts of the relay may fail and stick together by mistake, causing unexpected conducting of the charging loop of the battery pack. Therefore, the charger generally further includes a constant voltage control circuit 12. The constant voltage control circuit 12 is configured for ensuring that the voltage in the charging loop is within a safe range. The constant voltage control circuit 12 includes a switching tube, a three-terminal regulator U, a capacitor C, a third resistor R3, and a fourth resistor R4. The switching tube includes a first switching tube. A first terminal of the first switching tube, a first terminal of the third resistor R3, and a ground terminal of the three-terminal regulator U are all grounded. A second terminal of the first switching tube, a second terminal of the third resistor R3, a sampling terminal of the three-terminal regulator U, a first terminal of the fourth resistor R4, and a first terminal of the capacitor C are connected to each other. A control terminal of the three-terminal regulator U, a second terminal of the capacitor C, and a second terminal of the fourth resistor R4 are all connected to the power supply. A control terminal of the first switching tube is connected to the battery pack status detection circuit 11. The battery pack status detection circuit 11 is configured to control to enable conduction between the first terminal and the second terminal of the first switching tube in a case where the present status meets the charging requirement.

The switching tube may further include a second switching tube. The switching tubes are connected in series between the control terminal of the three-terminal regulator U and the ground. A control terminal of the second switching tube is connected to the emitter of the transistor Q4 in the control circuit 13. The second switching tube is turned on when the emitter of the transistor Q4 is energized. The first switching tube and the second switching tube are in series connection. In the series connection, each switching tube has two ports not connected to any other switching tube. One of the ports not connected to any other switching tubes is grounded, and the other one of the ports not connected to any other switching tubes is connected to the control terminal of the three-terminal regulator U.

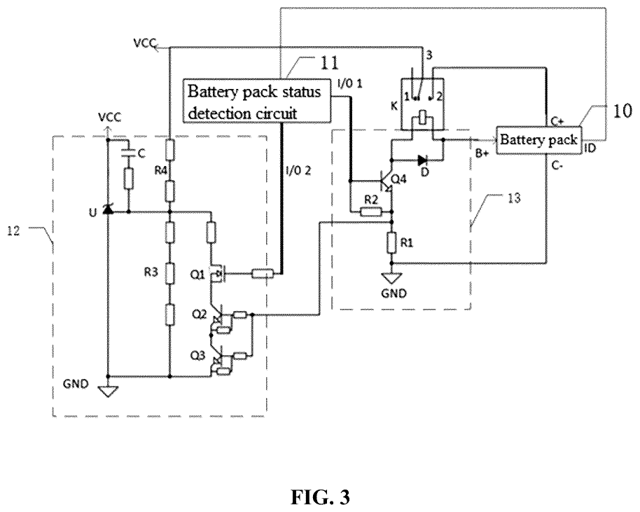

FIG. 3 is a structural diagram of a charger including a constant voltage control circuit 12 according to an embodiment of the present disclosure. It should be noted that the quantities and circuit structures of components in FIG. 1 to FIG. 3 are exemplary in the present disclosure, and do not limit other solutions in the present disclosure. As shown in FIG. 3, in addition to the components as in FIG. 2, FIG. 3 further includes a constant voltage control circuit 12. The constant voltage control circuit 12 includes a MOSFET Q1, a transistor Q2, a transistor Q3, a third resistor R3, a fourth resistor R4, a capacitor C, and a three-terminal regulator U. The quantities and models of the components are not limited. In FIG. 3, there are three third resistors R3 and two fourth resistors R4. The MOSFET Q1 serves as the first switching tube. The transistor Q2 and the transistor Q3 serve as the second switching tube. A specific connection is as follows. The MOSFET Q1, the transistor Q2, and the transistor Q3 are connected in series; a drain of the MOSFET Q1 is connected to the sampling terminal of the three-terminal regulator U through a resistor; and the emitter of the transistor Q3 is grounded. Resistors are further provided at locations in the circuit, such as resistors connected in series with the capacitor C. An I/O port 2 of the battery pack status detection circuit 11 is connected to the gate of the MOSFET Q1 (the first switching tube).

A control terminal of the first switching tube is connected to the battery pack status detection circuit 11. The battery pack status detection circuit 11 is configured to control to turn on the first switching tube in a case where the present status meets a charging requirement. A control terminal of the second switching tube is connected to the emitter of the transistor Q4 in the control circuit 13. The second switching tube is turned on when the emitter of the transistor Q4 in the control circuit 13 is energized. The control terminals of the two switching tubes provided above are connected to different circuits. The first switching tube is connected to the battery pack status detection circuit 11. The first switching tube is turned on when a voltage and temperature of the battery pack 10, a battery model and a battery capacity of the battery pack 10, and the like, meet a charging requirement. The control terminal of the second switching tube is connected to the emitter of the transistor Q4. The second switching tube is turned on when the loop where the coil of the relay K is located is energized. The switching tubes provide multiple safeguards to the charging loop. To avoid damage of some of the switching tubes from causing incorrect conducting of the constant voltage control circuit 12, the first switching tube and/or the second switching tube may be in a quantity of more than one. It should be noted that the switching tubes in the embodiment of the present disclosure may all be MOSFETs or all be transistors, or may be a combination of MOSFETs and transistors. When the switching tubes are not all turned on, an output voltage of the power supply is controlled within a safe range. Even if the contacts of the relay are accidentally stuck together, the voltage in the charging loop of the charger does not exceed the safe range and no serious safety accident occurs. The output voltage of the power supply rises only when all the switching tubes are turned on, thereby providing normal power supply to the battery pack.

The switching tube in the above embodiment may be a transistor, or may be a MOSFET. In a specific solution of an embodiment of the present disclosure, the switching tubes are MOSFETs. That is, the first switching tube is a first MOSFET, and the second switching tube is a second MOSFET. In a case where the switching tubes are all MOSFETs, a specific connection is as follows. A gate of the first MOSFET is connected to the battery pack status detection circuit 11. In a case where the present status meets the charging requirement, the battery pack status detection circuit 11 inputs a voltage to the gate of the first MOSFET. A gate of the second MOSFET is connected to the emitter of the transistor Q4. A drain and a source in the MOSFET serve as a first terminal and a second terminal of the MOSFET, respectively.

In the above embodiment, the solution where the relay K is adopted as the switch is illustrated. However, in actual applications, the type of the switch is not limited to the relay K. In an implementation according to another embodiment, the switch is specifically a MOSFET. A drain of a MOSFET Q7 serving as the switch is connected to the power supply, and a source of the MOSFET Q7 serving as the switch is connected to a positive electrode of the battery pack 10. The first terminal of the control circuit 13 is connected to a gate of the MOSFET Q7 serving as the switch. The control circuit 13, when being energized, controls to enable conduction between the source and the drain of the MOSFET Q7 serving as the switch.

In practical applications, the number of MOSFETs Q7 serving as the switch is not specifically limited, and may be set to more than one. Correspondingly, multiple MOSFETs Q7, serving as the switch, are connected in series through mutual connection of drains and sources. The first terminal of the control circuit 13 is connected to gates of the MOSFETs Q7 serving as the switch.

In addition, to prevent the battery pack 10 from charging the power supply, a blocking element is further included in a solution of an embodiment. The blocking element is disposed between the power supply and the battery pack 10, for preventing the battery pack 10 from charging the power supply. A specific type of the blocking element is not limited, and may be a diode or MOSFET. In a case where a diode is adopted as the blocking element, an anode of the diode is close to the power supply, and a cathode of the diode is close to the battery pack 10. In a case where the blocking element is a MOSFET, a source of a MOSFET Q8 serving as the blocking element is close to the power supply, and a drain of the MOSFET Q8 serving as the blocking element is close to the battery pack 10. The first terminal of the control circuit 13 is connected to a gate of the MOSFET Q8 serving as the blocking element.

As mentioned in the above embodiment, in an actual application, the charger may further include a battery pack status detection circuit 11 configured to detect a present status of the battery pack 10. Here, in a scenario where the switch is specifically a MOSFET, a specific structure of the control circuit 13 and a connection relationship with the battery pack status detection circuit 11 are provided. Specifically, the control circuit 13 includes a control MOSFET Q5, a control transistor Q6, a fifth resistor R5, a sixth resistor R6, and a seventh resistor R7. The battery pack status detection circuit 11 is connected to a gate of the control MOSFET Q5, and is configured to input a voltage to the control MOSFET Q5 in a case where the present status meets a charging requirement of the battery pack 10. A drain of the control MOSFET Q5 serves as the second terminal of the control circuit 13 and is configured to be connected to the discharge terminal of the battery pack 10. The battery pack 10 supplies power to the control circuit 13 when the discharge terminal of the battery pack 10 is connected to the second terminal of the control circuit 13. A source of the control MOSFET Q5, a first terminal of the fifth resistor R5, and a first terminal of the sixth resistor R6 are connected to each other. A second terminal of the fifth resistor R5 is grounded. A second terminal of the sixth resistor R6 is connected to a base of the control transistor Q6, an emitter of the control transistor Q6 is grounded, and a collector of the control transistor Q6 is connected to a first terminal of the seventh resistor R7. A second terminal of the seventh resistor R7 serves as the first terminal of the control circuit 13, and is configured to be connected to the gate of the MOSFET Q7 serving as the switch.

In addition, in a solution using the MOSFET as the switch, the charger may further include a constant voltage control circuit 12. As mentioned in the above embodiment, the constant voltage control circuit 12 includes a switching tube, a three-terminal regulator U, a capacitor C, a third resistor R3, and a fourth resistor R4. The switching tube includes a first switching tube. A first terminal of the first switching tube, a first terminal of the third resistor R3, and a ground terminal of the three-terminal regulator U are all grounded. A second terminal of the first switching tube, a second terminal of the third resistor R3, a sampling terminal of the three-terminal regulator U, a first terminal of the fourth resistor R4, and a first terminal of the capacitor C are connected to each other. A control terminal of the three-terminal regulator U, a second terminal of the capacitor C, and a second terminal of the fourth resistor R4 are all connected to the power supply. A control terminal of the first switching tube is connected to the battery pack status detection circuit 11. The battery pack status detection circuit 11 is configured to control to enable conduction between the first terminal and the second terminal of the first switching tube in a case where the present status meets the charging requirement. In addition, the switching tube may further include a second switching tube. The switching tubes are connected in series between the control terminal of the three-terminal regulator U and the ground. A control terminal of the second switching tube is connected to the source of the control MOSFET Q5 in the control circuit 13, the first terminal of the fifth resistor R5, and the first terminal of the sixth resistor R6. The second switching tube is turned on when the emitter of the control MOSFET Q5 is energized. The first switching tube and/or the second switching tube may be in a quantity of more than one, and all connected in series. The function of the constant voltage control circuit 12 is as described in the above embodiment and is not repeated here.

To ensure that the first terminal of the control circuit 13 is not energized if any control transistor Q6 fails, the sixth resistor R6 and the control transistor Q6 may be set in a quantity of more than one, and the control transistors Q6 are connected in series to each other through mutual connections of collector and emitters. Types of various components mentioned above are not limited and may be determined based on an actual situation.

According to the solution provided by the present disclosure, the switch may be implemented as a MOSFET or a relay. The switch is closed when the following two conditions are both satisfied. A first condition is that the battery pack status detection circuit 11 in a built-in chip detects that the battery pack has normal communication (where a communication content includes the number of battery packs in parallel, the number of battery packs in series, a capacity of a single battery cell, a real-time voltage of the battery pack, a real-time temperature of the battery pack, a battery pack communication code, and other status bits), and in this case a signal for requesting to close the switch is to be sent. A second condition is that the discharge terminal of the battery pack 10 supplies power to the control circuit 13. That is, the control circuit 13 can be energized only when the battery pack 10 is placed in the charging position, and can then control to close the switch to complete the charging loop.

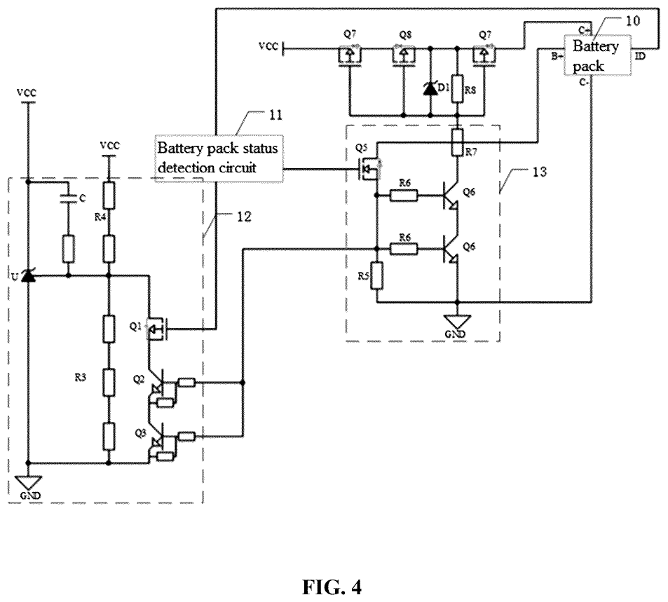

FIG. 4 is a structural diagram of a charger in which a switch is a MOSFET according to an embodiment of the present disclosure. As shown in FIG. 4, the charger includes a battery pack 10, a constant voltage control circuit 12, a control circuit 13, and a MOSFET Q7 serving as a switch, and a MOSFET Q8 serving as a blocking element, and the like. The control circuit 13 specifically includes a control MOSFET Q5, a fifth resistor R5, a sixth resistor R6, a control transistor Q6, and a seventh resistor R7. Ports of the battery pack are illustrated as follows: B+ (discharge terminal), C+ (charging terminal), COM (communication port), and B− (charge and discharge general ground). The VCC represents a high voltage across an output capacitor of a power supply (applicable to all topologies). A control terminal of the first switching tube (MOSFET Q1) is connected to the battery pack status detection circuit 11. A control terminal of the second switching tube (transistors Q2 and Q3) is connected to the source of the control MOSFET Q5 in the control circuit 13, the first terminal of the fifth resistor R5, and the first terminal of the sixth resistor R6. The battery pack status detection circuit 11 is connected to the gate of the control MOSFET Q5 through an I/O port. After the battery pack 10 is plugged into the charging position, the VCC is energized. When communication succeeds, the I/O port transmits a signal to request to turn on the control MOSFET Q5. In this case, the battery pack 10 is in a plugged state, the discharge terminal B+ is energized, the control MOSFET Q5 is turned on normally, and the two control transistors Q6 are turned on simultaneously. Then, the VCC voltage turns on the MOSFET Q7 serving as the switch, and the charging terminal C+ is energized. Hence, charging for the battery pack is realized.

To solve the above-mentioned technical problem, a charging method for a battery pack is further provided in the present disclosure. The method is applied to a charger for a battery pack, the charger including a switch and a control circuit 13. The switch is provided on a charging loop of a power supply, a first terminal of the control circuit 13 is connected to the switch, and a second terminal of the control circuit 13 is configured to be connected to a discharge terminal of the battery pack 10. The method includes: controlling, when the control circuit 13 is energized, to close the switch to complete the charging loop; where the battery pack 10 supplies power to the control circuit 13 when the discharge terminal of the battery pack 10 is connected to the second terminal of the control circuit 13.

The embodiments of the method correspond to the embodiments of the charger for a battery pack. Therefore, the embodiments of the method may refer to the description of the embodiments of the charger for a battery pack, and are not described in detail here.

The charging method for a battery pack provided in the present disclosure corresponds to the charger for the battery pack described above, and therefore has the same beneficial effects as the charger for the battery pack.

In applications, various situations may occur. For example, a model of the charger does not match that of the battery pack 10, or an internal structure of the battery pack 10 is damaged. In such cases, a serious accident may occur when charging the battery pack 10 through the charger. Hence, the charger for the battery pack further includes a battery pack status detection circuit 11. The battery pack status detection circuit 11 is configured to detect a present status of the battery pack 10. The battery pack status detection circuit 11 is connected to the control circuit 13. Before the controlling, when the control circuit 13 is energized, to close the switch to complete the charging loop, the method further includes: receiving the present status detected by the battery pack status detection circuit 11. The controlling, when the control circuit 13 is energized, to close the switch to complete the charging loop, includes: controlling to close the switch to complete the charging loop in a case where the discharge terminal of the battery pack 10 is connected to the second terminal of the control circuit 13 and the present status meets a charging requirement; where the present status includes a voltage and temperature of the battery pack 10, and a battery model and a battery capacity of the battery pack 10. In the embodiments of the present disclosure, the structure of the charger for a battery pack is not limited, and the structural diagram shown in FIG. 2 may be adopted. With the solution provided by the embodiments of the present disclosure, charging of the battery pack with a fault can be avoided, and thereby a serious accident is avoided.

To ensure the safety of the charger, the charger of the battery pack further includes a constant voltage control circuit 12 provided in the charging loop. The constant voltage control circuit 12 is configured to limit a voltage of the charging loop when the constant voltage control circuit is not energized, and increase the voltage of the charging loop when the constant voltage control circuit is energized. The control circuit 13, when being energized, controls to energize the constant voltage control circuit 12. In this way, the constant voltage control circuit 12 increases the voltage of the charging loop, so that the voltage in the charging loop meets the charging requirement. The embodiment of the present disclosure may adopt the structural diagram shown in FIG. 3.

The charger and the charging method for a battery pack provided by the present disclosure are described in detail above. The embodiments in the present disclosure are described in a progressive manner, and each of the embodiments focuses on its differences from the other embodiments. The same or similar parts among the embodiments may be referred to each other. It should be noted that improvements and modifications can be made to the present disclosure by those of ordinary skills in the art, without departing from the principles of the present disclosure. Such improvements and modifications fall within the protection scope of the claims in the present disclosure.

It should be noted that in the specification, relationship terminologies such as “first” and “second” are only used to distinguish one entity or operation from another entity or operation, rather than to necessitate or imply an actual relationship or order between the entities or operations. Moreover, terms “include”, “comprise” or any variants thereof are intended to be non-exclusive. Therefore, a process, method, article or device including a series of elements includes not only the elements but also other elements that are not enumerated, or further includes elements inherent to the process, method, article or device. Unless expressively limited otherwise, the statement “comprising (including) a(n) . . . ” does not exclude existence of other similar elements in the process, method, article or device.

1. A charger for a battery pack, the charger comprising a switch provided on a charging loop of a power supply, and a control circuit for controlling on/off of the switch;
wherein a first terminal of the control circuit is connected to the switch, and a second terminal of the control circuit is configured to be connected to a discharge terminal of the battery pack; the battery pack supplies power to the control circuit when the discharge terminal of the battery pack is connected to the second terminal of the control circuit; and the control circuit, when being energized, controls to close the switch to complete the charging loop.

2. The charger for the battery pack according to claim 1, wherein the control circuit is powered by only the battery pack; and in a case where the battery pack does not supply power to the control circuit, the control circuit controls to open the switch to disconnect the charging loop.

3. The charger for the battery pack according to claim 1, wherein the switch is a relay K, and the relay K has a normally open contact;
the first terminal of the control circuit is connected to a coil of the relay K; and the control circuit, when being energized, controls to energize the coil of the relay K.

4. The charger for the battery pack according to claim 3, further comprising a battery pack status detection circuit, wherein the battery pack status detection circuit is configured to detect a present status of the battery pack, the present status comprises a voltage and temperature of the battery pack, and a battery model and a battery capacity of the battery pack;
the control circuit comprises a first resistor R1, a second resistor R2, a transistor Q4, and a diode D;
the coil of the relay K, a collector and an emitter of the transistor Q4, and the first resistor R1 are connected in series between the discharge terminal of the battery pack and the ground;
the battery pack status detection circuit is connected to a base of the transistor Q4, and is configured to input a voltage to the transistor Q4 in a case where the present status meets a charging requirement of the battery pack;
a first terminal of the second resistor R2 is connected to the base of the transistor Q4, and a second terminal of the second resistor R2 is connected to the emitter of the transistor Q4; and an anode of the diode D is connected to a terminal of the coil of the relay K close to the ground, and a cathode of the diode D is connected to a terminal of the coil of the relay K close to the discharge terminal of the battery pack.

5. The charger for the battery pack according to claim 4, further comprising a constant voltage control circuit, wherein the constant voltage control circuit comprises a switching tube, a three-terminal regulator U, a capacitor C, a third resistor R3, and a fourth resistor R4; the switching tube comprises a first switching tube;
a first terminal of the first switching tube, a first terminal of the third resistor R3, and a ground terminal of the three-terminal regulator U are all grounded;
a second terminal of the first switching tube, a second terminal of the third resistor R3, a sampling terminal of the three-terminal regulator U, a first terminal of the fourth resistor R4, and a first terminal of the capacitor C are connected to each other;
a control terminal of the three-terminal regulator U, a second terminal of the capacitor C, and a second terminal of the fourth resistor R4 are all connected to the power supply;
a control terminal of the first switching tube is connected to the battery pack status detection circuit; and the battery pack status detection circuit is configured to control to enable conduction between the first terminal and the second terminal of the first switching tube, in a case where the present status meets the charging requirement.

6. The charger for the battery pack according to claim 5, wherein the switching tube further comprises a second switching tube;
the switching tubes are connected in series between the control terminal of the three-terminal regulator U and the ground;
a control terminal of the second switching tube is connected to the emitter of the transistor Q4 in the control circuit; and the second switching tube conducts when the emitter of the transistor Q4 is energized.

7. The charger for the battery pack according to claim 6, wherein the first switching tube and/or the second switching tube are in a quantity of more than one, and are all connected in series.

8. The charger for the battery pack according to claim 6, wherein the switching tube is a MOSFET, the first switching tube is a first MOSFET, and the second switching tube is a second MOSFET;
a gate of the first MOSFET is connected to the battery pack status detection circuit; and the battery pack status detection circuit is configured to input a voltage to the gate of the first MOSFET in a case where the present status meets the charging requirement;
a gate of the second MOSFET is connected to the emitter of the transistor Q4; and
a drain and a source in the MOSFET serve as a first terminal and a second terminal of the MOSFET, respectively.

9. The charger for the battery pack according to claim 1, wherein the switching tube is a MOSFET;
a drain of a MOSFET Q7 serving as the switch is connected to the power supply, and a source of the MOSFET Q7 serving as the switch is connected to a positive electrode of the battery pack;
the first terminal of the control circuit is connected to a gate of the MOSFET Q7 serving as the switch; and the control circuit, when being energized, controls to enable conduction between the source and the drain of the MOSFET Q7 serving as the switch.

10. The charger for the battery pack according to claim 9, wherein the MOSFET Q7 serving as the switch is in a quantity of more than one;
the MOSFETs Q7 serving as the switch are connected in series through mutual connections of drains and sources; and
the first terminal of the control circuit is connected to gates of the MOSFETs Q7 serving as the switch.

11. The charger for the battery pack according to claim 10, further comprising a blocking element, wherein
the blocking element is disposed between the power supply and the battery pack, for preventing the battery pack from charging the power supply.

12. The charger for the battery pack according to claim 11, wherein the blocking element is a diode; and
an anode of the diode is close to the power supply, and a cathode of the diode is close to the battery pack.

13. The charger for the battery pack according to claim 12, wherein the blocking element is a MOSFET;
a source of a MOSFET Q8 serving as the blocking element is close to the power supply, and a drain of the MOSFET Q8 serving as the blocking element is close to the battery pack; and
the first terminal of the control circuit is connected to a gate of the MOSFET Q8 serving as the blocking element.

14. The charger for the battery pack according to claim 9, further comprising a battery pack status detection circuit configured to detect a present status of the battery pack; wherein
the control circuit comprises a control MOSFET Q5, a control transistor Q6, a fifth resistor R5, a sixth resistor R6, and a seventh resistor R7;
the battery pack status detection circuit is connected to a gate of the control MOSFET Q5, and is configured to input a voltage to the control MOSFET Q5 in a case where the present status meets a charging requirement of the battery pack;
a drain of the control MOSFET Q5 serves as the second terminal of the control circuit and is configured to be connected to the discharge terminal of the battery pack;
a source of the control MOSFET Q5, a first terminal of the fifth resistor R5, and a first terminal of the sixth resistor R6 are connected to each other; a second terminal of the fifth resistor R5 is grounded;
a second terminal of the sixth resistor R6 is connected to a base of the control transistor Q6, an emitter of the control transistor Q6 is grounded, and a collector of the control transistor Q6 is connected to a first terminal of the seventh resistor R7; and
a second terminal of the seventh resistor R7 serves as the first terminal of the control circuit, and is configured to be connected to the gate of the MOSFET Q7 serving as the switch.

15. The charger for the battery pack according to claim 14, further comprising a constant voltage control circuit, wherein the constant voltage control circuit comprises a switching tube, a three-terminal regulator U, a capacitor C, a third resistor R3, and a fourth resistor R4; the switching tube comprises a first switching tube;
a first terminal of the first switching tube, a first terminal of the third resistor R3, and a ground terminal of the three-terminal regulator U are all grounded;
a second terminal of the first switching tube, a second terminal of the third resistor R3, a sampling terminal of the three-terminal regulator U, a first terminal of the fourth resistor R4, and a first terminal of the capacitor C are connected to each other;
a control terminal of the three-terminal regulator U, a second terminal of the capacitor C, and a second terminal of the fourth resistor R4 are all connected to the power supply;
a control terminal of the first switching tube is connected to the battery pack status detection circuit; and the battery pack status detection circuit is configured to control to enable conduction between the first terminal and the second terminal of the first switching tube, in a case where the present status meets the charging requirement.

16. The charger for the battery pack according to claim 15, wherein the switching tube further comprises a second switching tube;
the switching tubes are connected in series between the control terminal of the three-terminal regulator U and the ground;
a control terminal of the second switching tube is connected to the source of the control MOSFET Q5 in the control circuit; and the second switching tube conducts when the source of the control MOSFET Q5 is energized.

17. The charger for the battery pack according to claim 14, wherein the sixth resistor R6 and the control transistor Q6 are both in a quantity of more than one; and
the control transistors Q6 are connected in series through mutual connections of collectors and emitters.

18. A charging method for a battery pack, applied to a charger for the battery pack, the charger comprising a switch and a control circuit, wherein the switch is provided on a charging loop of a power supply, a first terminal of the control circuit is connected to the switch, a second terminal of the control circuit is configured to be connected to a discharge terminal of the battery pack; and the method comprises:
controlling, when being energized, to close the switch to complete the charging loop; wherein the battery pack supplies power to the control circuit when the discharge terminal of the battery pack is connected to the second terminal of the control circuit.

19. The charging method for the battery pack according to claim 18, wherein the charger for the battery pack further comprises a battery pack status detection circuit, the battery pack status detection circuit is configured to detect a present status of the battery pack, and the battery pack status detection circuit is connected to the control circuit; and
before the controlling, when being energized, to close the switch to complete the charging loop, the method further comprises:
receiving the present status detected by the battery pack status detection circuit; and
the controlling, when being energized, to close the switch to complete the charging loop comprises:
controlling to close the switch to complete the charging loop, in a case where the discharge terminal of the battery pack is connected to the second terminal of the control circuit and the present status meets a charging requirement; wherein the present status comprises a voltage and temperature of the battery pack, and a battery model and a battery capacity of the battery pack.

20. The charging method for the battery pack according to claim 18, wherein the charger for the battery pack further comprises a constant voltage control circuit provided in the charging loop; the constant voltage control circuit is configured to limit a voltage of the charging loop when the constant voltage control circuit is not energized, and increase the voltage of the charging loop when the constant voltage control circuit is energized; and the method further comprises:
controlling, when being energized, to energize the constant voltage control circuit.
